(19) United States
(12) Patent Application Publication
(10) Pub. No.: US 2020/0377119 A1
(43) Pub. Date: Dec. 3, 2020

(54) METHOD FOR OPERATING A VEHICLE GUIDING SYSTEM WHICH IS DESIGNED TO GUIDE A MOTOR VEHICLE IN A COMPLETELY AUTOMATED MANNER, AND MOTOR VEHICLE

(71) Applicant: AUDI AG, Ingolstadt (DE)

(72) Inventor: Rachid KHLIFI, Garching (DE)

(73) Assignee: AUDI AG, Ingolstadt (DE)

(21) Appl. No.: 16/960,833

(22) PCT Filed: Jan. 10, 2019
(86) PCT No.: PCT/EP2019/050586

§ 371 Date: Aug. 21, 2020

(30) Foreign Application Priority Data
Jan. 18, 2018 (DE) 10 2018 200 814.0

(51) Int. Cl. B60W 60/00; G01S 7/41; G01S 13/34; G01S 13/536; G01S 13/56; G01S 13/931

(52) U.S. Cl. CPC B60W 60/001; G01S 7/415; G01S 13/343; G01S 13/536; B60W 30/18154; G01S 13/931; B60W 2420/52; B60W 2555/60; G01S 13/56

(57) ABSTRACT

The present disclosure relates to a method for operating a vehicle guiding system of a motor vehicle, said vehicle guiding system being designed to guide the motor vehicle in a completely automated manner. The presence of a traffic officer and/or instruction data which describes a traffic instruction provided by the traffic officer is ascertained by analyzing sensor data of at least one surroundings sensor of the motor vehicle and taken into consideration during the completely automated guidance of the vehicle. At least one radar sensor with a semiconductor chip which acts as a radar transceiver is used as the surroundings sensor, and upon detecting the presence of a traffic officer, the radar sensor is switched from at least one normal operating mode to an additional operating mode provided for detecting limbs of the traffic officer and/or their movement, wherein the sensor data of the radar sensor is analyzed for instruction data which describes the limbs of the traffic officer and/or their movement.

### TECHNICAL FIELD

The present disclosure relates to a method for operating a vehicle guiding system of a motor vehicle, said vehicle guiding system being designed to guide the motor vehicle in a completely automated manner, wherein the presence of a traffic officer and/or instruction data which describes a traffic instruction provided by the traffic officer is ascertained by analyzing sensor data of at least one surroundings sensor of the motor vehicle and taken into consideration during the completely automated guidance of the vehicle. The present disclosure also relates to a motor vehicle.

### BACKGROUND

Autonomous vehicle guiding systems, which are designed to guide the motor vehicle in a completely automated manner, have recently been the focus of research. What is important here is the precise detection of dynamic and static targets in the surroundings of the ego-vehicle, that is to say the own motor vehicle. A dynamic and static map of the vehicle's surroundings (surroundings map) can be generated by sensor fusion. Depending on the detected surroundings objects, which are described by the surroundings map, an evaluation/analysis of the traffic situation is carried out and, depending on this, measures are triggered and/or a trajectory planning is carried out. Autonomous vehicle guiding systems are designed to relieve the driver, particularly in complex and critical traffic situations. The development of the actual vehicle guiding function is accompanied by advances in sensor technology.

The use of radar sensors in motor vehicles is already widely known in the prior art. Radar sensors are nowadays usually used as surroundings sensors for a medium and larger distance range in order to be able to determine the distance, angle and relative speed of other road users or larger objects. Such radar data can be used by surroundings models or also be made directly available to vehicle systems. In the known prior art, it is, for example, longitudinal guidance systems (ACC), or also security systems that make use of radar data. The use of radar sensors in the interior of the motor vehicle has also previously been proposed.

Radar sensors of conventional design usually have larger dimensions and are rather bulky since the antennas and the electronic components needed directly on the antenna, i.e., the radar front end, are integrated in a housing. The electronic components mainly constitute the radar transceiver, which contains a frequency control (usually comprising a phase-locked loop—PLL), mixing devices, a low noise amplifier (LNA) and the like, but control modules and digital signal processing components are often also implemented close to the antenna, for example, in order to be able to supply already processed sensor data, such as object lists, on a connected bus, such as a CAN bus.

The implementation of semiconductor-based radar components has long proved difficult, as expensive specialty semiconductors, particularly GaAs, have been required. Smaller radar sensors have been proposed, of which the entire radar front end was implemented on a single chip using SiGe technology before solutions using CMOS technology also became known. Such solutions are the result of extending CMOS technology to high frequency applications, often referred to as RF CMOS. Such a CMOS radar chip is designed to be extremely compact and does not use expensive special semiconductors and above all offers significant advantages over other semiconductor technologies, especially in production. An exemplary implementation of a 77 GHz radar transceiver as a CMOS chip is described in the article by Jri Lee et al., “A Fully Integrated 77-GHz FMCW Radar Transceiver in 65-nm CMOS Technology,” IEEE Journal of Solid State Circuits 45 (2010), pp. 2746-2755.

Following the additional proposal to implement the chip and the antenna in a shared package, a very low-cost small radar sensor is obtainable, which can meet the space requirements significantly better and also has a very low signal-to-noise ratio because of the short signal paths and is suitable for high frequencies and greater, variable frequency bandwidths. Such small-sized radar sensors can, therefore, also be used for short-range applications, for example, in the range of 30 cm to 10 m.

It has also been proposed to provide such a CMOS transceiver chip and/or a package having a CMOS transceiver chip and an antenna with a digital signal processing processor (DSP processor) on a joint printed circuit board, or to also integrate the functions of the signal processor in the CMOS transceiver chip. A similar integration is possible for control functions.

For future completely automated vehicle guiding functions in urban regions, various critical traffic situations have to be taken into account. An example of this is a deployment of the traffic officer at a traffic light in an intersection area, where the male or female traffic officer (hereinafter, for the sake of simplicity, “traffic officer”) regulates traffic. In intersection scenarios, the traffic light detection can be implemented, for example, using a camera as a surroundings sensor. There are various challenges with regard to traffic regulation by the traffic officer, for example, the distinction between the traffic officer and pedestrians crossing and the recognition of the instructions given by the traffic officer.

In this context, DE 10 2013 219 038 A1 discloses a method for detecting an officer by a driver assistance system, wherein images of the vehicle surroundings are recorded by means of a camera on the vehicle side, the image data of the images recorded are evaluated by means of an image evaluation stored in the driver assistance system, and using the evaluated image data a police officer is automatically detected. In this way, a driver assistance system, which is equipped in particular with a traffic light assistant and/or a traffic sign assistant, is able to detect a police officer regulating the traffic and to that extent react to the police officer instead of a traffic light or a traffic sign. For example, it is possible to intervene autonomously or partially autonomously in the guidance of the motor vehicle by reducing the priority of a detected traffic light phase or a detected traffic sign or by ignoring them. However, cameras are heavily affected by factors such as ambient brightness and surroundings influences. Cameras are also less suitable with regard to 3D detection and thus the detection of hand signals and the like.

DE 10 2015 004 605 A1 describes a method for operating a control system of the mobile unit which is designed for guiding a mobile unit in a completely automated manner, in particular a motor vehicle, wherein the sensor data of at least one surroundings sensor of the mobile unit are analyzed for determining instruction data which describe the presence of a person authorized to output traffic instructions and/or at least one traffic instruction output by the person. Upon detecting a person authorized to output traffic instructions, a relevance criterion which evaluates the instruction data and/or the sensor data and describes the relevance of a determined and/or general traffic instruction for the mobile unit is analyzed, wherein the traffic instruction for the mobile unit is taken into consideration if the relevance criterion is met when guiding the mobile unit in a completely automated manner. Various types of sensors are conceivable as the surroundings sensor of the motor vehicle, optical sensors, in particular a camera, and/or transit time sensors, in particular a radar sensor, preferably being used as surroundings sensors. There are no more detailed explanations for evaluating the sensor data.

The subject-matter of DE 10 2014 111 023 A1 is a method and a device for controlling an automated vehicle with the following features: The vehicle detects an ambiguous traffic situation, analyzes the recorded traffic situation, selects a planned interaction with at least one road user based on the analysis of the detected traffic situation, signals the interaction to the road user, records a reaction of the road user to the interaction, and evaluates the reaction and initiates the planned driving maneuver depending on the evaluation of the reaction. The interaction partner can be a traffic officer. Sensors used can include a video camera, a hodometer 14, a GPS sensor, or a system 16 for optical distance or speed measurement (Light Detection and Ranging, LiDAR).

### BRIEF DESCRIPTION OF DRAWINGS/FIGURES

FIG. 1 shows a possible traffic situation at an interaction.

FIG. 2 shows possible instructions from a traffic officer.

FIG. 3 shows a flow chart of one exemplary embodiment of a method, in accordance with some embodiments.

FIG. 4 shows a motor vehicle, in accordance with some embodiments.

### DETAILED DESCRIPTION

The present disclosure is therefore based on the object of specifying a possibility for reliable traffic situation analysis when regulated by the traffic officer.

To achieve this object, in some embodiments, a method of the type mentioned initially provides that at least one radar sensor with a semiconductor chip which acts as a radar transceiver is used as the surroundings sensor, and upon detecting the presence of a traffic officer, the radar sensor is switched from at least one normal operating mode to an additional operating mode provided for detecting limbs of the traffic officer and/or their movement, wherein the sensor data of the radar sensor is analyzed for instruction data which describes the limbs of the traffic officer and/or their movement.

In some embodiments, the present disclosure is based on the finding that the recent advances in radar technology, which provide new, high-resolution radar sensors in semiconductor technology, for example CMOS technology, lead to a particular suitability of this type of surroundings detection in order to detect gestures and hand signals of a traffic officer from motor vehicles, which is an important step towards increasing the usability, safety, and reliability of functions for guiding a vehicle in a completely automatic manner. For example, a semiconductor chip can also be used, which in addition to the radar transceiver also implements a digital signal processing component (DSP) and/or a control unit of the radar sensor and/or is implemented as a package with an antenna arrangement of the radar sensor. In this way, due to the high level of integration, signal paths are further shortened, the signal-to-noise ratio improves and the quality of the sensor data of the radar sensor increases, with which limbs and/or their movements can be detected better and more reliably. This applies in particular since generally radar sensors based on semiconductors, for example CMOS, allow reliable detection even in regions of near and medium distance, which particularly affect a traffic officer.

In some embodiments, the use of such radar sensors based on semiconductors, where, for example, three radar sensors can be concealed in a front bumper, allows the more flexible adaptation of detection properties by correspondingly changing the operating parameters. By way of a non-limiting example, semiconductor radar sensors are particularly suitable for operation in different operating modes, to which different detection properties are assigned. At least one such operating mode, the additional operating mode, is explicitly designed for the requirements of the detection of instructions from the traffic officer, and a switch is made from a normal operating mode, for example for the general detection of static and dynamic objects in city traffic, to the additional operating mode to obtain sensor data from the radar sensor that has been specially matched to the evaluation of instruction data. In some embodiments, if a plurality of radar sensors are used, only some of these radar sensors may have to be switched to the additional operating mode in order to maintain the other detection properties in parallel.

In some embodiments, when the traffic officer regulating the traffic is determined, the at least one radar sensor is switched to the additional operating mode, where it records sensor data that are particularly suitable for detecting the instructions of the traffic officer. Sensor data of the at least one radar sensor can also be used in normal operating mode in order to enable and/or support a distinction between traffic officers and other pedestrians as road users, since different behaviors, and thus different movement patterns and/or positions by the radar reflections are reproduced. In this context, the radar sensor carries out an angle measurement in two mutually perpendicular planes in order to enable three-dimensional scanning of the surroundings of the motor vehicle, in particular the surroundings in front. In particular, an angle detection in elevation and azimuth is provided. Special antenna arrangements can be used for this, in which individual antenna elements follow one another in two directions perpendicular to one another. In some embodiments, radar sensors can be used that combine an elevation measurement capability with a high lateral resolution and thus allow a reliable classification of static and dynamic targets even in more complex urban traffic scenarios.

In some embodiments, it can be provided that in the additional operating mode a Doppler resolution better than 0.1 m/s, in particular by using more than 400 rising ramps with frequency modulation in the radar signal, and/or a frequency bandwidth of at least 2 GHz are used. For example, in a preferred embodiment, 500 rising ramps can be used in an FMCW radar. At least 4 GHz is preferably used as the frequency bandwidth in order to enable a high distance resolution, for example a distance resolution of 5 cm at 4 GHz. Of course, other and/or further operating parameters of the radar sensor in the additional operating mode can also be adapted to the intended detection of limbs and/or movements of limbs of the traffic officer.

In some embodiments, the instruction data are determined at least partially from the radar sensor data, in particular with regard to the identification of the limbs and/or the evaluation of the movement of the limbs, by means of a micro Doppler analysis. The micro Doppler effect is the fact that movements of an object that deviate from the overall movement of the object produce Doppler modulations around the main Doppler shift, which is also referred to as a micro Doppler signature. By evaluating this micro Doppler signature, information about the corresponding movements of subunits of the object, in the present case limbs of the traffic officer, can be derived.

In some embodiments, an evaluation algorithm of artificial intelligence is used at least partially to determine the instruction data from the sensor data of the radar sensor. In particular, training methods of so-called “deep learning” can be used to train this evaluation algorithm of artificial intelligence. For example, typical reflection patterns or micro Doppler signatures can be assigned to corresponding limb positions/movements in order to determine the instruction data.

In some embodiments, in addition to the fact that radar sensors already make an important contribution to the classification of pedestrians in the traffic surroundings during the identification of traffic officers, in particular also in the dark, by means of micro Doppler signs, instructions from the traffic officer can also be detected. In addition to the procedure described using an evaluation algorithm of artificial intelligence, it can also be provided that typical reflection patterns of limb movements and/or limb positions are stored in a database within the motor vehicle, in particular in the radar sensor, and a comparison is carried out in the analysis and interpretation of the traffic situation between the stored reflection patterns and the currently recorded reflection patterns, as described by the sensor data of the radar sensor. The radar reflection patterns are preferably horizontal and vertical, so that a 3D interpretation of the objects and here in particular the parts of objects, namely the limbs, can be carried out statically and dynamically.

In some embodiments, the presence of a traffic officer is detected at least partially from sensor data of a camera as a surroundings sensor. Especially with regard to the classification of pedestrians with regard to their clothing and the like, with regard to traffic officer's uniform, the use of cameras has particular advantages. For example, a regulation of the traffic determined by sensor data of the camera by a traffic officer can also result in the radar sensor being switched to the additional operating mode, whereby, however, as the previous explanations have shown, sensor data of other surroundings sensors, in particular of the radar sensor, can also be taken into consideration.

It some embodiments, in addition to the radar sensor, at least one camera and at least one lidar sensor are used as surroundings sensors, the sensor data of the different sensor types being used for joint evaluation and/or for the mutual plausibility check of evaluation results. In order to build a reliable system for completely automated driving, it is advisable to provide a redundancy of a plurality of measuring principles. A combination of radar sensors, cameras, and lidar sensors can be used as the surroundings sensor system in order to ensure reliable analysis and interpretation of an intersection situation as a traffic situation with traffic officer and traffic lights. Cameras are rather weak in terms of speed measurement, but deliver the highest performance in the classification of objects (pedestrians, traffic lights, color of traffic lights and the like). Lidar sensors optically scan the surroundings and provide additional details for interpreting the traffic situation. Radar sensors are particularly useful with regard to the movement of objects, which can be achieved by evaluating the Doppler signal and/or preferably also by micro Doppler analysis.

In some embodiments, upon detecting the presence of a traffic officer, the result of a traffic light switch detection is given a lower priority than the instruction data. The traffic light detection function is, therefore, given a low priority and/or is completely ignored, while the instruction data describing the signs of the traffic officer are given high priority. Accordingly, the completely automatic operation of the motor vehicle is also based on the determined instruction data. For example, if the instruction data describes that the traffic officer gives a left-turn signal, a trajectory with a turning maneuver to the left is used in a motor vehicle to take account of the instruction data. In other words, the vehicle guiding system takes into consideration the position of one's own motor vehicle relative to the traffic officer, the infrastructure of the intersection, which can be determined, for example, using predictive route data (PSD) or sensor data from the surroundings sensors, and the other merged information on the traffic situation, optimal path planning through and controls the operation of the motor vehicle accordingly.

In some embodiments, the motor vehicle is guided to the detected traffic officer in order to maintain a minimum distance. In this way, a safety distance between the motor vehicle and the traffic officer is maintained.

In some embodiments, evaluation algorithms and/or databases, which are taken into consideration when determining the instruction data from the sensor data of the radar sensor, can certainly be country- and/or region-specific if there are corresponding differences, so that depending on the traffic country/traveled region a correct evaluation and detection of the instructions of the traffic officer can take place.

In some embodiments, a motor vehicle is disclosed. The motor vehicle has at least one surroundings sensor designed as a radar sensor and a vehicle guiding system designed for guiding the motor vehicle in a completely automated manner and a control unit designed to carry out the method according to one or more embodiments, as described in the present disclosure. All statements relating to the method, as described in the present disclosure, can be transferred analogously to the motor vehicle.

Further advantages and details of the embodiments of the present disclosure will become apparent from the exemplary embodiments described below and with reference to the drawings. In the drawings:

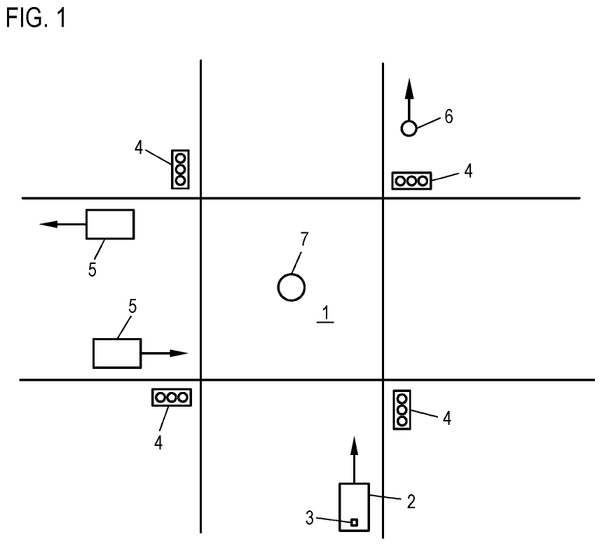

FIG. 1 shows a schematic diagram of a traffic situation at an intersection 1, to which a motor vehicle 2 according to some embodiments, as described in the present disclosure, which has a vehicle guiding system 3 designed for guiding the motor vehicle 2 in a completely automated manner, which evaluates sensor data from surroundings sensors (not shown here) and has a control unit, which is designed to carry out the method, according to some embodiments as described herein, is discussed below. The surroundings sensors include at least one radar sensor directed towards the forefield of motor vehicle 2 and having a semiconductor chip which acts as a radar transceiver.

In according with some embodiments, for guiding a motor vehicle 2 in a completely automated manner, it is substantial to correctly assess the traffic situation at the intersection 1, which is usually regulated using the traffic lights 4. In the present case, however, in addition to other road users, in particular other motor vehicles 5 and pedestrians 6, there is also a traffic officer 7 in the region of the intersection 1, the latter taking over the traffic control from the traffic light system 4. For operating the motor vehicle 2 in a completely automated manner by the vehicle guiding system 3, it is substantial in the situation shown not only to determine that the traffic officer 7 is present, but also to be able to detect his instructions, which can be conveyed by the position of the limbs and/or the movement thereof.

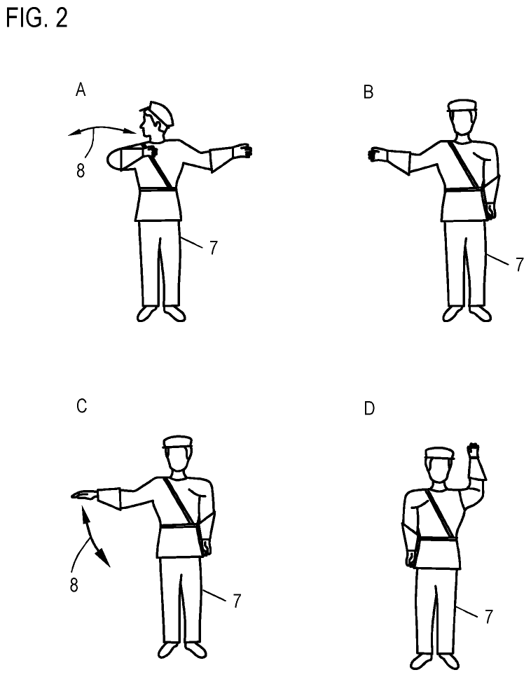

Exemplary instructions are shown in FIG. 2. The arrows 8 each indicate a movement of limbs. In sub-picture A, a motor vehicle is waved through; in sub-picture B, motor vehicles that approach from the front and rear have to stop, while motor vehicles that approach from the side are allowed to continue driving. In sub-picture C, the motor vehicles are to be slowed down, while in sub-picture D motor vehicles are to stop.

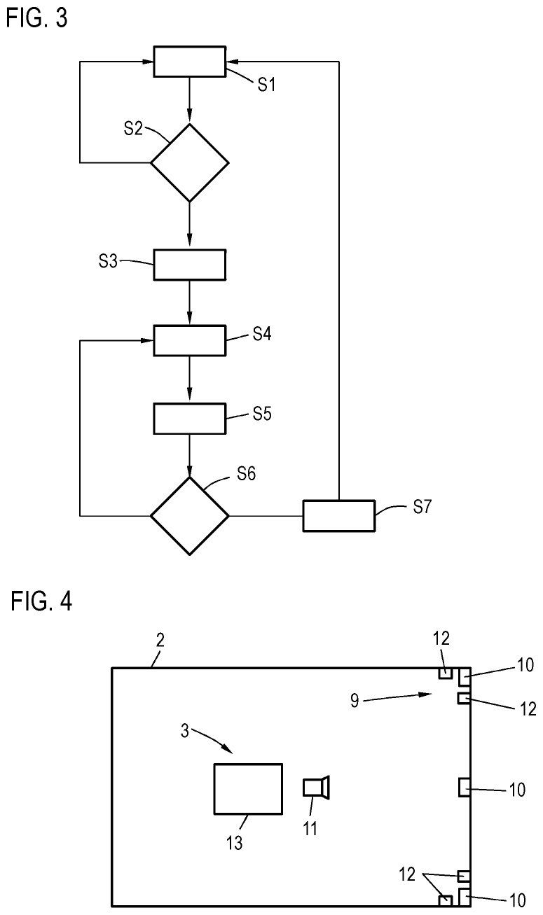

FIG. 3 shows a flow chart of an exemplary embodiment of the method according to some embodiments, as described herein, with regard to intersection situations shown in FIG. 1. As the motor vehicle 2 approaches the intersection 1, in a step S1, as usual, sensor data from the surroundings sensors are recorded and merged/evaluated accordingly. In addition to the already mentioned radar sensor based on semiconductor technology, the surroundings sensors include at least one forward-facing camera and at least one forward-facing lidar sensor, wherein by means of the semiconductor chip of the radar sensor, here a CMOS chip, also a digital signal processing component and a control unit of the radar sensor can be realized, wherein the semiconductor chip acts as a package together with an antenna arrangement of the radar sensor and an angle measurement is possible for the antenna arrangement in two mutually perpendicular planes by means of an antenna arrangement, here azimuth and elevation. Static objects, for example the traffic lights 4, other road users, and dynamic objects, for example the other motor vehicles 5 and/or the pedestrians 6, and also traffic officers 7, can be detected in the sensor data of the surroundings sensors.

In addition to guiding the motor vehicle in a completely automatic manner, the evaluation of the sensor data in a step S2 in the present case checks whether a traffic officer 7 relevant to the motor vehicle 2 has been detected. The detection of the traffic officer 7 preferably takes place mainly based on sensor data from the camera, since this allows pedestrians 6 to be classified particularly well according to their function. Of course, further sensor data, in particular sensor data of the radar sensor, can also be received here, for example since the sensor data of the radar sensor allow a better position determination with respect to the traffic officer 7 and can already provide information on the position/movement of the limbs of the traffic officer 7, which indicates whether the traffic officer 7 actually regulates the traffic (together with his position in the middle of the intersection 1). The radar sensor has so far been operated in a normal operating mode for city traffic.

As long as no relevant traffic officer 7 is identified, the usual completely automatic guidance of motor vehicle 2 is continued according to step S1, which in particular also includes detection and interpretation of traffic light signals.

However, if a traffic officer 7 is detected who is relevant to motor vehicle 2, in particular is located at an intersection 1 in front, in step S3 a lower prioritization of traffic light signals is set compared to instruction data to be determined, and on the other hand the at least one radar sensor is switched to an additional operating mode, which is specifically geared to the detection of limbs of the traffic officers 7 or their movement. Here, in the additional operating mode 500, increasing ramps of frequency modulation are used in order to achieve a Doppler resolution of 0.1 m/s, and secondly a frequency bandwidth of 4 GHz is used, which leads to a distance resolution of 5 cm or less. Since it is a semiconductor radar sensor, in particular a CMOS radar sensor, such switching of operating modes and a corresponding adjusting of operating parameters can be easily implemented.

In a step S4, the sensor data of the radar sensor are evaluated in order to determine the limbs of the traffic officer 7 and/or instruction data describing their movement. Of course, sensor data from the at least one camera and/or the at least one lidar sensor can also be used to check the plausibility and/or improve the evaluation. In the present case, at least one micro Doppler analysis is carried out for evaluating the sensor data of the radar sensor, since this detects movements of the limbs in a particularly reliable manner. Radar reflection patterns in general and in particular the micro Doppler signatures can be compared with typical reflection patterns in a database, which can be stored in the control unit or in the radar sensor, wherein in addition or alternatively, an evaluation algorithm of artificial intelligence can be expediently used to classify reflection patterns, in particular comprising micro Doppler signatures.

In a step S5, the motor vehicle 2 is operated in accordance with the instruction data determined in step S4, which means that the instructions of the traffic officer 7 described by the instruction data are taken into consideration accordingly when operating the motor vehicle 2, a minimum distance from the traffic officer 7 also being maintained. If the traffic officer 7 therefore gives the sign to slow down, as shown by way of example in FIG. 2C, the speed of the motor vehicle 2 is reduced. If a sign is given to turn to the right (see sub-picture A in FIG. 2), the path planning is carried out in such a way that the future trajectory of motor vehicle 2 leads to a right turn.

In a step S6 it is then checked whether the traffic officer 7 is still present or relevant, comparable to step S2, it being possible, for example, to monitor whether the motor vehicle 2 has already passed the traffic officer 7 or has left the intersection 1 and the like. In particular, sensor data of the other surroundings sensors can also be used here. If the traffic officer 7 is still relevant, the process continues with step S4, otherwise the radar sensor is switched back to the corresponding normal operating mode in a step S7 and the process is continued again in step S1, wherein the traffic light data describing the traffic light signals, as present, are prioritized again as usual.

FIG. 4 shows a schematic diagram of the motor vehicle 2, in accordance with some embodiments. Only the surroundings sensors 9, which are directed towards the forefield of the motor vehicle 2 and are therefore relevant for the configurations are described here. By way of a non-limiting example, other surroundings sensors can also be provided in order to achieve a detection that covers the entire surroundings of motor vehicle 2 in a 360° radius.

The surroundings sensors 9 include radar sensors 10, which are concealed in semiconductor technology, such as CMOS technology, in a bumper of the motor vehicle 2, which acts as a package comprising an antenna arrangement and a semiconductor chip, such as a CMOS chip, which in addition to a radar transceiver, also acts as a digital signal processing component of the radar sensor 10 and a control unit of the radar sensor 10. The control unit can be used to switch between different operating modes of the radar sensor 10, for example from the normal operating mode to the additional operating mode and vice versa.

Other surroundings sensors include a camera 11 directed at the forefield of the motor vehicle 2 and lidar sensors 12. The sensor data of all these sensors are transmitted to a control unit 13 of the vehicle guiding system 3, which is designed to carry out the method according to the various embodiments, as described herein.

1.-10. (canceled)

11. A method for operating a vehicle guiding system of a motor vehicle, wherein the vehicle guiding system is designed to guide the motor vehicle in an automated manner, the method comprising:
ascertaining, during guiding the motor vehicle in the automated manner, presence of a traffic officer or instruction data which describes a traffic instruction provided by a traffic officer based on analysis of sensor data of at least one surrounding sensor of the motor vehicle for determining instruction data describing a plurality of limbs or a movement of the plurality of limbs of the traffic officer; and
upon asserting the presence of the traffic officer, switching from a first operating mode to a second operating mode, the second operating mode is configured to detect the plurality of limbs of the traffic officer or the movement of the plurality of limbs.

12. The method of claim 11, wherein the at least one surrounding sensor is a radar sensor.

13. The method of claim 12, wherein the radar sensor acts as a radar transceiver, and wherein the radar sensor includes a semiconductor chip.

14. The method of claim 11, further comprising using at least one of a Doppler resolution better than 0.1 m/s, more than 400 rising ramps with frequency modulation in the radar signal, and a frequency bandwidth of at least 2 GHz.

15. The method of claim 11, further comprising performing a micro Doppler analysis for determining the instruction data from the sensor data of the radar sensor.

16. The method of claim 11, further comprising using an evaluation algorithm of artificial intelligence for determining the instruction data from the sensor data of the radar sensor.

17. The method of claim 12, wherein the radar sensor is configured to take an angle measurement in two mutually perpendicular planes.

18. The method of claim 11, wherein the surrounding sensor is a camera.

19. The method of claim 11, wherein the at least one surrounding sensor comprises at least one camera, at least one lidar sensor, and at least one radar sensor, the method further comprising performing joint evaluation or mutual plausibility check of a plurality of evaluation results based on the sensor data comprising sensor data from the at least one camera, the at least one lidar sensor, and the at least one radar sensor.

20. The method of claim 11, further comprising upon detecting the presence of the traffic officer, lowering priority of a result of a traffic light switch detection in comparison to the instruction data.

21. The method of claim 11, further comprising maintaining a minimum distance from the detected traffic officer.

22. A motor vehicle, comprising:
at least one surrounding sensor;
a vehicle guiding system designed to guide the motor vehicle in an automated manner comprising a control unit,
wherein the control unit is configured to:
ascertain, during guiding the motor vehicle in the automated manner, presence of a traffic officer or instruction data which describes a traffic instruction provided by a traffic officer based on analysis of sensor data of the at least one surroundings sensor for determining instruction data describing a plurality of limbs or a movement of the plurality of limbs of the traffic officer, and
upon asserting the presence of the traffic officer, switch from a first operating mode to a second operating mode, the second operating mode is configured to detect the plurality of limbs of the traffic officer or the movement of the plurality of limbs.
